(19) United States
(12) Patent Application Publication
(10) Pub. No.: US 2013/0332865 A1
(43) Pub. Date: Dec. 12, 2013

(54) ACTIVITY INITIATION AND NOTIFICATION USER INTERFACE

(71) Applicants: Stephen Michael Danton, Seattle, WA (US); Jonah B. Sterling, Seattle, WA (US); Michael Bach, Seattle, WA (US); Jefferson King, Bellevue, WA (US); Jesse David Francisco, Lake Stevens, WA (US); Adam Mohamed Abdelhamed, Bellevue, WA (US); Mark S. D'Urso, Redmond, WA (US); Jonathan Harris, Sammamish, WA (US); Karandeep Singh Anand, Redmond, WA (US); Bharat Ahluwalia, Redmond, WA (US); S. Morris Brown, Seattle, WA (US); William J. Staples, Duvall, WA (US); Dina-Marie Ledonne Supino, Seattle, WA (US)

(72) Inventors: Stephen Michael Danton, Seattle, WA (US); Jonah B. Sterling, Seattle, WA (US); Michael Bach, Seattle, WA (US); Jefferson King, Bellevue, WA (US); Jesse David Francisco, Lake Stevens, WA (US); Adam Mohamed Abdelhamed, Bellevue, WA (US); Mark S. D'Urso, Redmond, WA (US); Jonathan Harris, Sammamish, WA (US); Karandeep Singh Anand, Redmond, WA (US); Bharat Ahluwalia, Redmond, WA (US); S. Morris Brown, Seattle, WA (US); William J. Staples, Duvall, WA (US); Dina-Marie Ledonne Supino, Seattle, WA (US)

(73) Assignee: MICROSOFT CORPORATION, Redmond, WA (US)

(21) Appl. No.: 13/612,708

(22) Filed: Sep. 12, 2012

Related U.S. Application Data
(60) Provisional application No. 61/656,349, filed on Jun. 6, 2012.

(51) Int. Cl. G06F 3/048

(52) U.S. Cl. 715/764

(57) ABSTRACT

A user interface that includes an activity initiation area that includes an activity initiation control that may be interacted with in order to initiate respective activities, and a notification area in which one or more notifications related to the activity may be displayed. The notification area is spatially related to the activity initiation control in a fixed manner for multiple activities. The activity initiation area may appear along a lower boundary of the display much as a partially pulled out drawer as viewed from above. The notification area may also appear along the lower boundary of the display, but extend further vertically, much as a fully pulled out drawer as viewed from above. This helps give a contextual understanding of the subject matter of the notifications in relation to the activities that have been, or may be, initiated from the activity initiation area.

### CROSS-REFERENCE TO RELATED APPLICATIONS

The present application claims priority under 35 U.S.C. 119(e) to U.S. provisional application Ser. No. 61/656,349 filed Jun. 6, 2012, which provisional patent application is incorporated herein by reference in its entirety.

### BACKGROUND

Computing systems have transformed the way we work, play, and communicate, particularly with the proliferation of the Internet and other networking technologies. User interfaces allow human beings to interface with a computing system, to thereby provide input to the computer programs executing on the computing systems.

Often notifications related to an activity being performed on the computing system pop-up to appear in a separate window or appear in a distinct dialog box. The human user is then task with interpreting the notification, identify which activity the notification relates to, and then determine how the notification relates to the notification, in order to fully interpret the notification. Sometimes too much information is provided in the notification resulting in information overload, and sometimes too little information is provided resulting in uncertainty as to what the notification means.

### BRIEF SUMMARY

At least one embodiment described herein relates to a user interface that includes an activity initiation area that includes an activity initiation control that may be interacted with in order to initiate respective activities. The user interface also includes a notification area in which one or more notifications related to the activity may be displayed. The notification area is spatially related to the activity initiation control in a fixed manner for multiple activities. As an example, the activity initiation area may appear along a lower boundary of the display much as a partially pulled out drawer as viewed from above. In that case, perhaps the notification area may also appear along the lower boundary of the display (as an extension of the activity notification area, or replacing the activity notification area), but extend further vertically, much as a fully pulled out drawer as viewed from above. This helps give a contextual understanding of the subject matter of the notifications in relation to the activities that have been, or may be, initiated from the activity initiation area.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 abstractly illustrates a user interface that may be displayed on, for example, the display of FIG. 1, and which includes an activity initiation area and a notification area;

FIG. 3 illustrates an example user interface in which an activity initiation area, that has activity initiation controls, appears extended along a boundary of the user interface;

FIG. 4A illustrates a user interface that is similar to the user interface of FIG. 3, except that a notification area is displayed in immersive mode;

FIG. 4B illustrates a user interface that is similar to the user interface of FIG. 3, except that a notification area is displayed in contextual mode;

FIG. 5A illustrates a user interface in which an activity initiation area appears, but without a notification area;

FIG. 5B illustrates a user interface in which an activity initiation area appears along with a summary help notification area in contextual mode;

FIG. 5C illustrates a user interface in which a detailed help notification area is displayed in immersive mode with the activity initiation area hidden;

FIG. 5D illustrates a user interface that is similar to the user interface of FIG. 5C, except that the help content and options have changed in response to changes in the context of the primary application work area;

FIG. 6 illustrates a flowchart of a method for displaying the notification area in response to user input in accordance with embodiments described herein;

FIG. 7 illustrates an example user interface of a Create New activity;

FIG. 8 illustrates a user interface in which the activity notification area, presented as a drawer, is collapsed, and cannot be seen by the user;

FIG. 9 illustrates a user interface in which the activity notification area is presented in immersive mode as associated with a Create New activity;

FIG. 10 illustrates a user interface in which an activity drawer includes an activity initiation area in which the user initiates the command using an activity initiation control;

FIG. 11 illustrates an example user interface that uses a global cascading create concept;

FIG. 12 illustrates an example user interface prior to invoking the global cascade create notification area;

FIG. 13 illustrates an example user interface showing a result of the control actuation of FIG. 12;

FIG. 14 illustrates the principles of global cascaded creation;

FIG. 15 illustrates a user interface, which is similar to that of FIG. 14, except with example user input provided into the New Item Details section;

FIG. 16 shows a user interface that includes a notification area that shows status for a long running operation;

FIG. 17 illustrates the signal notification area in detail mode, which is expanded when the user selects the expansion control of FIG. 16;

FIG. 18 illustrates a user interface that shows a drilled-in view of content within the notification area;

FIG. 19 illustrates that the notification area may present multiple long running operations in a single location;

FIG. 20 illustrates a signal notification area that presents the confirmation experience directly adjacent to the command that requires confirmation;

FIG. 21 illustrates the expanded signal notification area of the confirmation of FIG. 20;

FIG. 22 illustrates a signal notification area that presents a system warning;

FIG. 23 illustrates a signal notification area that presents a system errors; and

FIG. 24 illustrates a signal notification area that presents information notifications.

### DETAILED DESCRIPTION

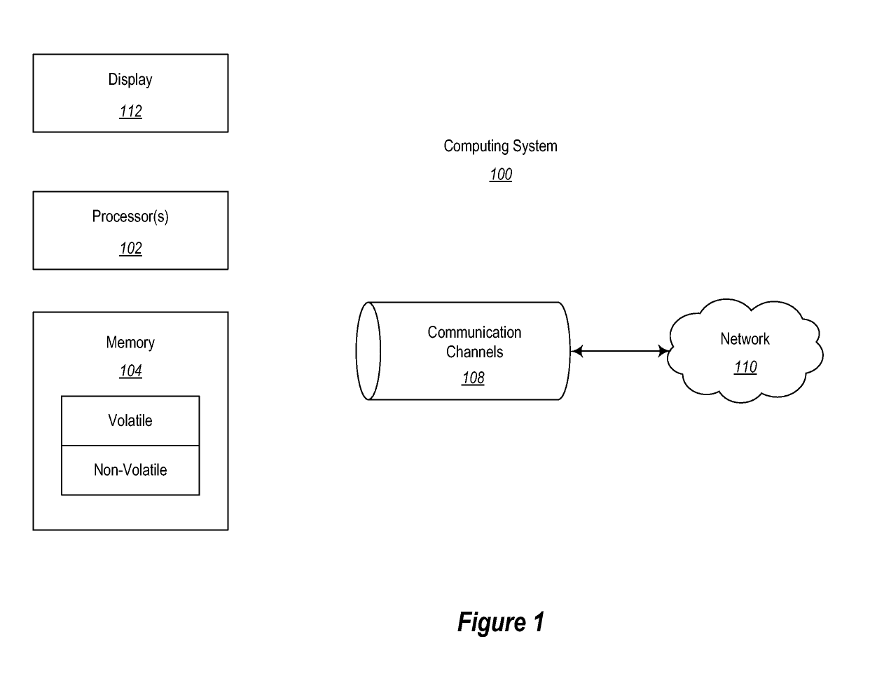

In accordance with embodiments described herein, a user interface is described that includes an activity initiation area that includes an activity initiation control that may be interacted with in order to initiate respective activities. The user interface also includes a notification area in which one or more notifications related to the activity may be displayed. The notification area is spatially related to the activity initiation control in a fixed manner for multiple activities. As an example, the activity initiation area may appear along a lower boundary of the display much as a partially pulled out drawer as viewed from above. In that case, perhaps the notification area may also appear along the lower boundary of the display (as an extension of the activity notification area, or replacing the activity notification area), but extend further vertically, much as a fully pulled out drawer as viewed from above. This helps give a contextual understanding of the subject matter of the notifications in relation to the activities that have been, or may be, initiated from the activity initiation area. Such user interfaces may be implemented on a display 112 of the computing system 100 of FIG. 1. Accordingly, some introductory discussion of a computing system will be described with respect to FIG. 1. Then, embodiments of the user interface will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 may also have a display (such as display 112) on which user interfaces, such as the user interface described herein, may be visualized to a user.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

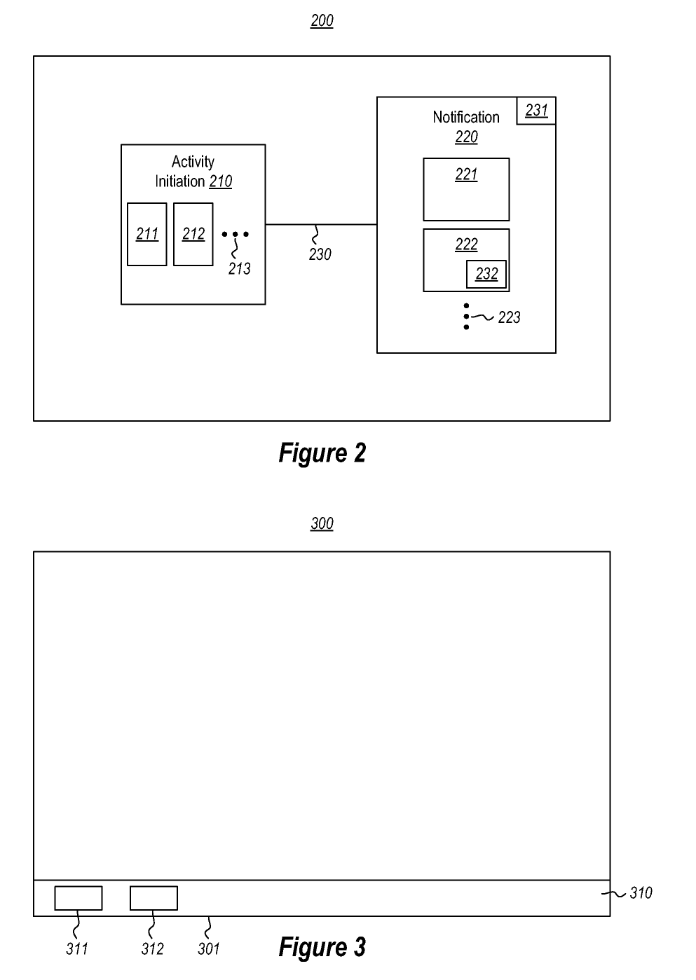

FIG. 2 abstractly illustrates a user interface 200 that may be displayed on, for example, the display 112 of FIG. 1. The user interface 200 may be rendered, for example, by the computing system 100 using processors 102 to execute computer-executable instructions. The user interface includes an activity initiation area 210 and a notification area 220. Specific examples of the user interface 200 are provided further below. Accordingly, user interface 200 is just an abstract representation.

The notification area 220 is temporarily displayed. Accordingly, there may be times when the activity initiation area 210, but not the notification area 220, is displayed in the user interface 200. The notification area 220 is spatially related 230 to the activity initiation area 210 in a fixed manner regardless of the controls that are within the activity initiation control, and regardless of the activities that the controls initiate.

The activity initiation area 210 includes activity initiation controls 211 and 212. However, the ellipses 213 represent flexibility in the number of activity initiation controls within the activity initiation area 210. There may be as few as one, but perhaps many activity initiation controls. Each activity initiation control may be interacted with by a user in order to initiate a corresponding activity. The identity of the activity initiation controls, and corresponding activities, may be context sensitive and depend on the content of the remainder of the user interface. Thus, the activity initiation controls 211, 212 and 213 may change dynamically.

The user interface 200 also includes a notification area 220 in which one or more notifications 221 and 222 may be displayed. The notifications displayed are related to one or more of the activities corresponding to the activity initiation controls 211 and 212. Although two notifications 221 and 222 are illustrated, the ellipses 223 abstractly represent that there may be other numbers of notifications as well from as few as one, to potentially many.

The notifications may include additional controls that the user may interact with. For instance, the notification 222 includes a link 232 that may be selected to navigate to further content related to the notification 222. The notification area 220 may also contain a link that may be selected to navigate to further content related to the activity. The notification area 220 may also include an expansion control 231 that may be selected to display more details regarding the notifications or the corresponding activity, or even to present more controls.

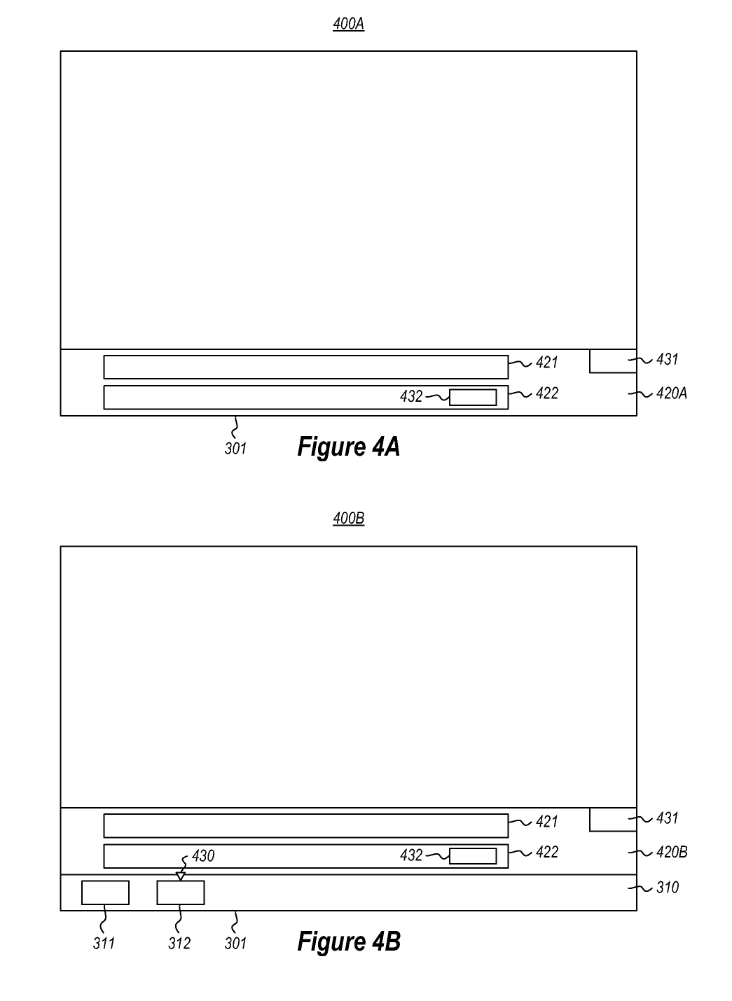

FIG. 3 illustrates a user interface 300 in which the activity initiation area 310 (which has activity initiation controls 311 and 312) appears extended along a boundary 301 of the user interface 300. Although that boundary could be any boundary of the user interface such as a vertical boundary (e.g., left or right boundary), or a horizontal boundary (e.g., upper or lower boundary), the boundary 301 is illustrated as being the lower boundary in FIG. 3. The identity of the activity initiation controls 311 and 312 and their corresponding activity may depend on the context of what is being displayed in the remainder of the user interface.

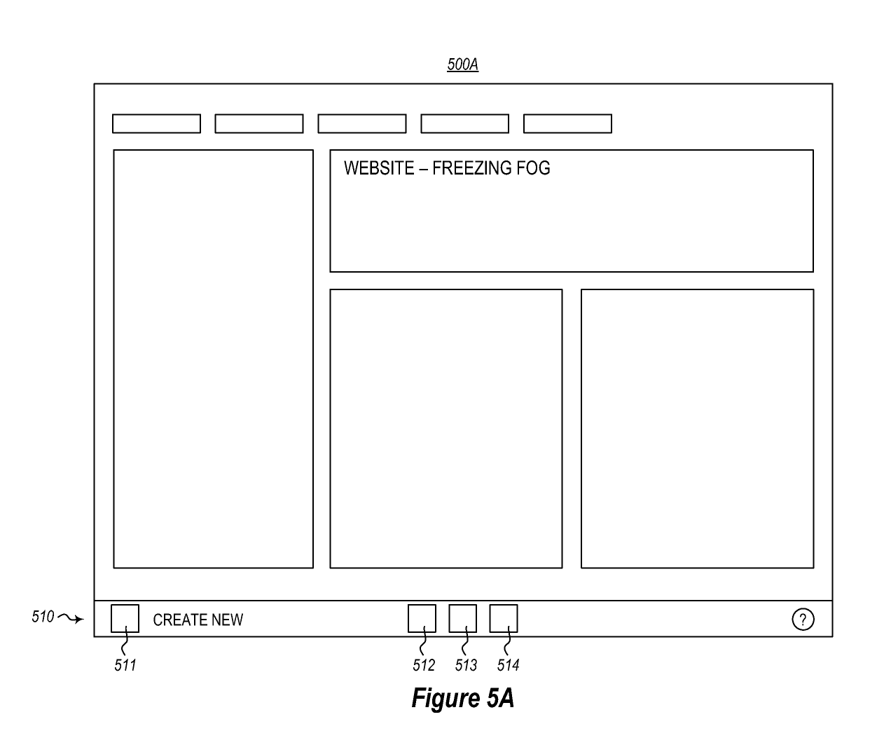

FIG. 4A illustrates a user interface 400A in which a notification area 420A is displayed. The notification area 420A also appears along the same boundary (e.g., the lower boundary 301) of the user interface as the activity initiation area 310 did, but can extend further in a direction away from the boundary (e.g., upwards away from the lower boundary 301 in FIG. 4A). In the case of FIG. 4A, however, the notification area 420A appears, while the activity initiation area 310 is hidden. This will be often referred to as the “immersive mode” below. The notification area 420A includes notifications 421 and 422, being examples of the notifications 221 and 222 of FIG. 2. The notification area 420A also includes an expansion control 431 that represents an example of the expansion control 231 of FIG. 2, and a control 432 (e.g., a link) that represents an example of the control 232 of FIG. 2.

FIG. 4B illustrates a user interface 400B in which a notification area 420B is displayed. The notification area 420B also appears along the same boundary (e.g., the lower boundary 301) of the user interface as the activity initiation area 310 does, but again can extend further in a direction away from the boundary (e.g., upwards away from the lower boundary 301 in FIG. 4B). In the case of FIG. 4B, the notification area 420B appears, while the activity initiation area 310 remains. This will be often referred to as the “contextual mode” below. The notification area 420B of FIG. 4B appears similar to the notification area 420A of FIG. 4A, except that the notification area 420B is adjacent the activity initiation area in the direction perpendicular to the boundary that the activity initiation area 310 borders.

In this contextual mode, a contextual tether 430 visualizes a connection of the notification area 420B with a particular activity initiation control. In the example of FIG. 4, this is represented by an upside down triangle spanning that border of the activity initiation area 310 and the notification area 420B, pointing downwards towards the activity initiation control 312 that initiates the activity that the notifications 421 and 422 relate to.

Comparing FIGS. 3 and 4A, the notification 410A has the same position along the direction of the boundary (e.g., the same horizontal position) as the activity initiation area 310. Also, comparing FIGS. 3 and 4B, the notification 410B has the same position along the direction of the boundary (e.g., the same horizontal position) as the activity initiation area 310. This gives an intuitive visualization to the user. When the activity initiation area 310 appears alone, is appears as a dresser drawer, slightly open, as viewed from above. When the notification area 410A or 410B is displayed, is gives the appearance of a dresser drawer in a further open position. If the expansion control 431 is selected, this may yet further extend the notification area 410A or 410B in the perpendicular direction (e.g., vertically in FIGS. 4A and 4B) giving the sensation of the drawer opening yet further.

Specific user interface examples and applications of this concept will be described further below. In a first example, help notifications may be displayed in the notification area, the help notifications relating to an activity that may be initiated (or that has been initiated) using an activity initiation control within the activity initiation area. In the remainder of the examples, notifications appear relating to an activity already initiated by the user selecting a corresponding activity initiation control in the activity initiation area. In each of the examples, the notifications are presented in drawer form, in which the activity initiation area and/or the notification area are presented as pull up drawers from the lower boundary of the user interface. First, the help notifications embodiment will be described.

1) Help Notifications

Traditional approaches to help systems see the help exposed as a pop-up dialog, a separate web site, or integrated help area in a property pane. These approaches all suffer from being disconnected (as in the pop-up or web site approach) or too small to be useful (such as the property pane approach). In addition, none of them embrace a progressive reveal experience, which is more useful and usable for users. The help system describe herein automatically guide the users with initial help snippets, exposes detailed help when the user asks for it, and then provides links to reference/whitepaper style help as appropriate.

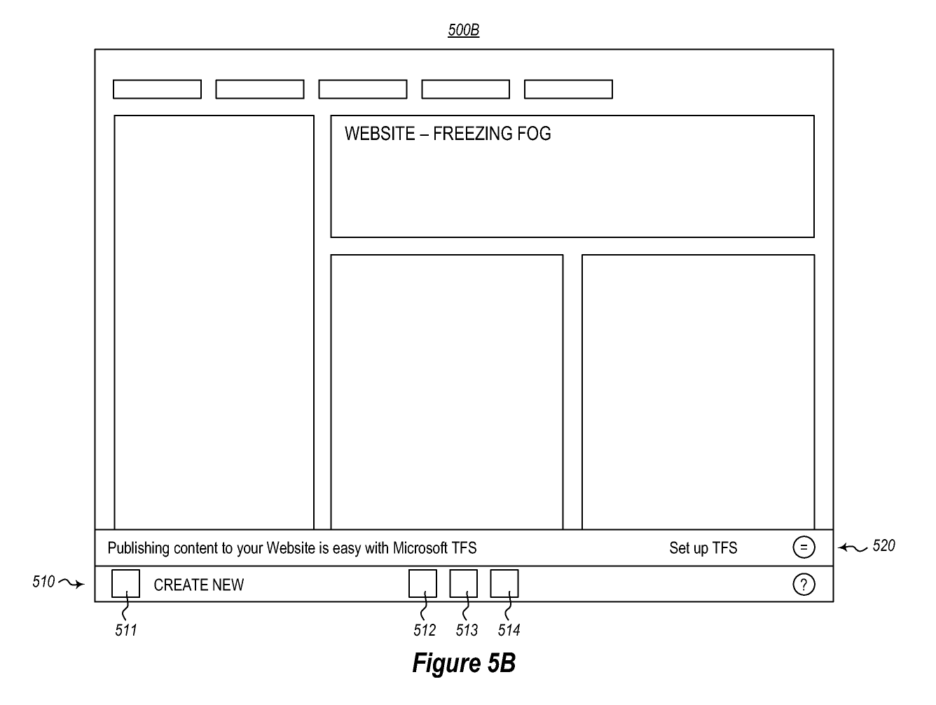

The following describes and illustrates a help signal. In one embodiment, this help signal is the minimal form of the help drawer. A domain (e.g. web site and database) can choose to automatically display a help signal when a user loads a page within their experience (e.g. Website\Dashboard or Website\Configure). FIG. 5A illustrates a user interface 500A in which no help signal notification is displayed. An activity initiation area 510 is displayed having activity initiation controls 511, 512, 513 and 514, but the remainder of the user interface 500A contains application content.

FIG. 5B illustrates a user interface 500B, which is similar to the user interface 500A of FIG. 5A, except that a notification area 520 is displayed. This may happen upon detecting that a notification is to be displayed such as in response to an event such as the user loading a page within the domain.

Contextual actions can be surfaced in the help signal notification 520 to expedite user flow through the user interface. If the user selects the help signal notification 420, it may expand into detail mode allowing the user to see a much richer view of the help information, plus any peer topics that the domain deems interesting for their users. FIG. 5C illustrates a user interface 500C, which is similar to the user interface 500B, except that the notification 520′ has been modified to show further notification details. Furthermore, though FIG. 5B shows the notification area 520 in contextual mode (with the activity initiation area 510 also displayed), FIG. 5C illustrates the detailed notification in immersive mode (with the activity initiation area 510 hidden).

If the user switches context in the primary application work area, the help content of the help signal notification may change accordingly. FIG. 5D illustrates a user interface 500D, which is similar to the user interface 500C of FIG. 5C, except that the help signal notification 520″ has been further modified so that its content is more contextual towards changes in the primary application work area. For instance, comparing FIGS. 5C and 5D, the user has switched from a web site context, to a database context. Thus the “HELP” options have also changed reflecting this context change. The user interface of FIG. 5A represents an example of the user interface 300 of FIG. 3. The user interface of FIG. 5B represents an example of the user interface 400B of FIG. 4B. The user interfaces of FIGS. 5C and 5D represent examples of the user interface 400A of FIG. 4A.

This help notification embodiment again avoids breaking the user's foci of attention by presenting help in a consistent and central location. Help is located and presented in the same manner no matter where the user is in the context of the primary application work area. Unlike a popup dialog or web page based help, the user is delivered help content in a very consistent way.

Also, the help is initially presented as a one line notification signal at the bottom of the user's content, out of the way of what they care about most. When expanded into details view, the help remains at the bottom of the user's content, sliding up to provide reading room, but designed so that the help does not block the user's general context.

Furthermore, the help is presented in a management free manner. Rather than popup in a dialog that is distracting and requires the user to dismiss it or reposition it, help appears, can be used, and then auto-closes as soon as the user moves to another task (e.g. clicks on content).

In addition, the help is presented in a minimal form with just enough information to understand what a user might learn from expanding the help drawer, or a bit of guidance about their current activity. Users can then expand help to see more information. If help is not of interest, the help may be automatically closed after a reasonable amount time (perhaps a few seconds).

This help notification concept is both content and navigation aware, and because it is a core piece of the user interface, as opposed to a popover dialog, the help drawer is displayed across navigations. For instance, if the user opens the help drawer while working on a website, they can navigate to a database and the content of the help drawer will automatically update. In this way the help drawer functions very much like a guidance system, by responding the user's current context.

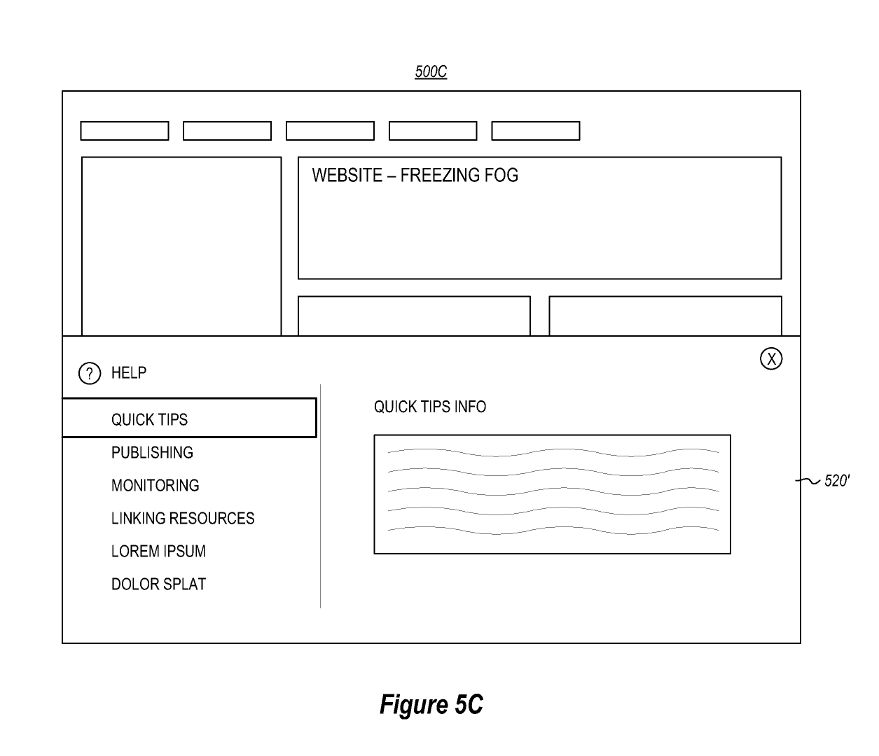

In further examples of notifications, the notification area appears when the user interacts with an activity initiation control. FIG. 6 illustrates a flowchart of a method 600 for displaying the notification area in response to user input. The method 600 may be performed by, for example, the computing system 100 of FIG. 1.

The activity initiation area is displayed in the user interface (act 601). The activity interface includes one or more activity initiation controls as previously described. The computing system then detects user interaction with the activity initiation control (act 602). In response, the computing system initiates the activity (act 603), and displays the notification area (act 604) that contains one or more notifications related to the initiated activity. Three further example categories of user interfaces will now be described in which the notification area is displayed after the user initiates an activity using an activity initiation control in the activity initiation area. The three example categories will be referred to as “activity notifications”, “global cascading create notifications”, and “signal notifications”.

2) Activity Drawer

Traditional approaches to performing activities and tasks have the user executing commands (i.e., “activity initialization”) in one work space (often called a “command space”), and then have the user perform the task of working on the activity or task (i.e., the “working experience”) in a different area, often within a dialog, or disconnected pane. The activity drawer (or activity notification) concept unifies the activity initialization and working experience within one conceptual and positional interface. Furthermore, the activity drawer concept reduces cognitive dissonance between activity initialization, and activity work as well as the number of user contexts and user interface concepts which require end-user learning.

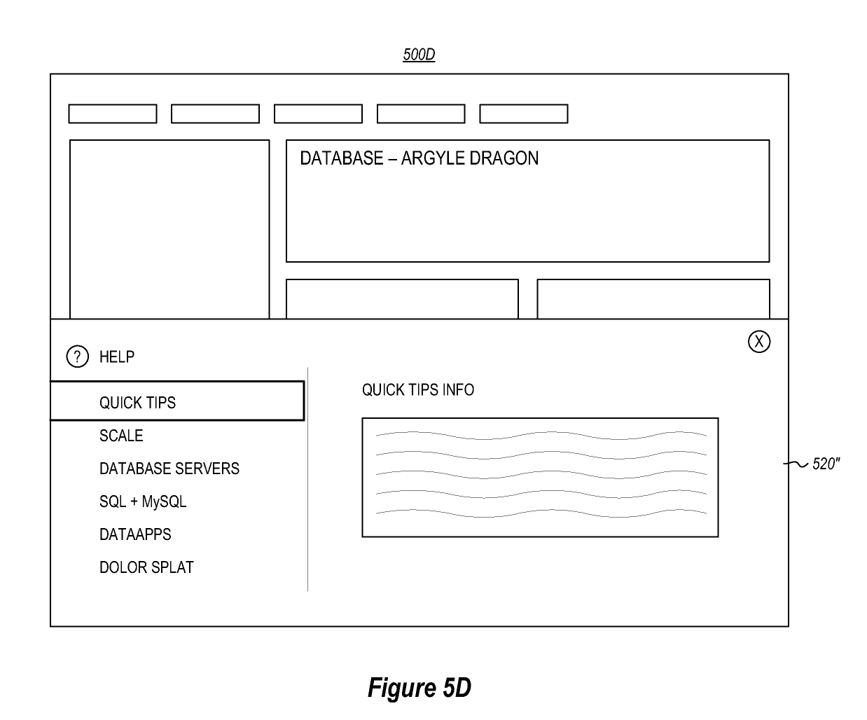

FIG. 7 illustrates an example user interface 700 of just one of the activities that may be performed; namely, Create New. The details of Create New are described further below, as that activity provides its own unique advantages over the fundamental benefits of the basic activity notification.

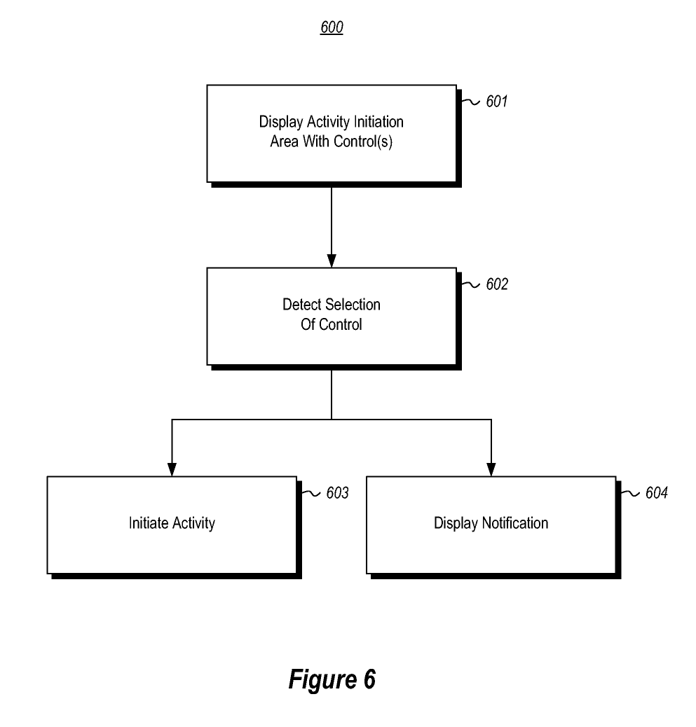

FIG. 8 illustrates a user interface 800, in which the activity notification area, presented as a drawer, is collapsed, and cannot be seen by the user. In other words, other than the primary application work area, only the activity initiation area 810 is displayed. The notification area appears when the user starts an activity that causes the notification area to appear. The notification area does not stay up, and require user management, and thus allows for a much more management-free experience.

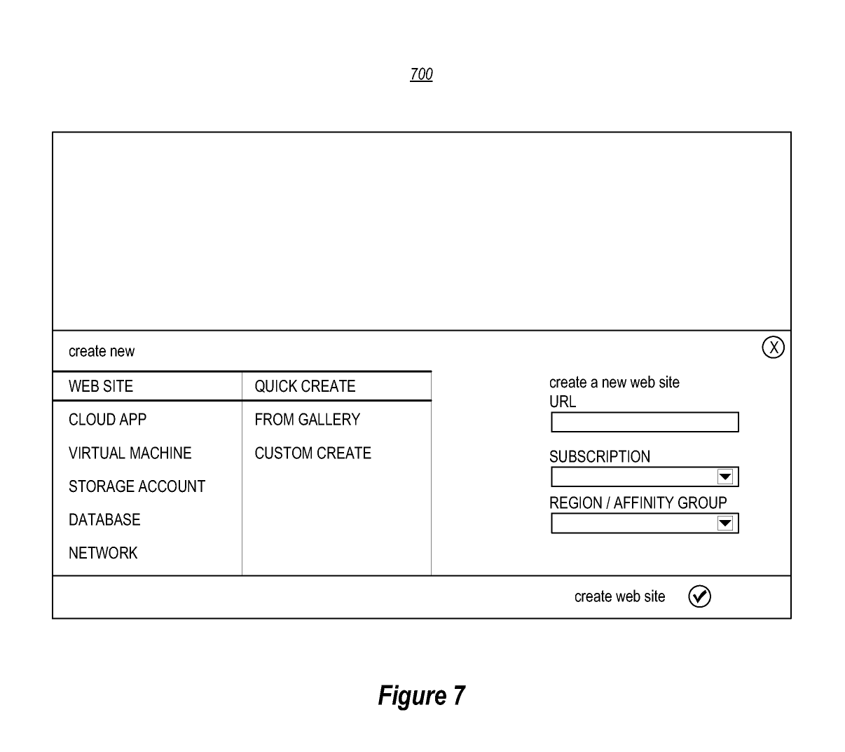

As previously mentioned, the activity notification area may be presented in two modes: immersive mode and contextual mode Immersive mode is used for tasks like Create New Item and Content Help commands Immersive mode is presented such that the activity initiation area is covered upon presentation of the notification area. This allows the user to focus on a single task without distraction. FIG. 9 illustrates a user interface 900 in which the activity notification area 920 is presented in immersive mode as associated with a Create New activity. The activity notification area 920 includes a command space (i.e., controls) that the user may interact with to read information and/or enter information to thereby complete the task begun by initiating the command.

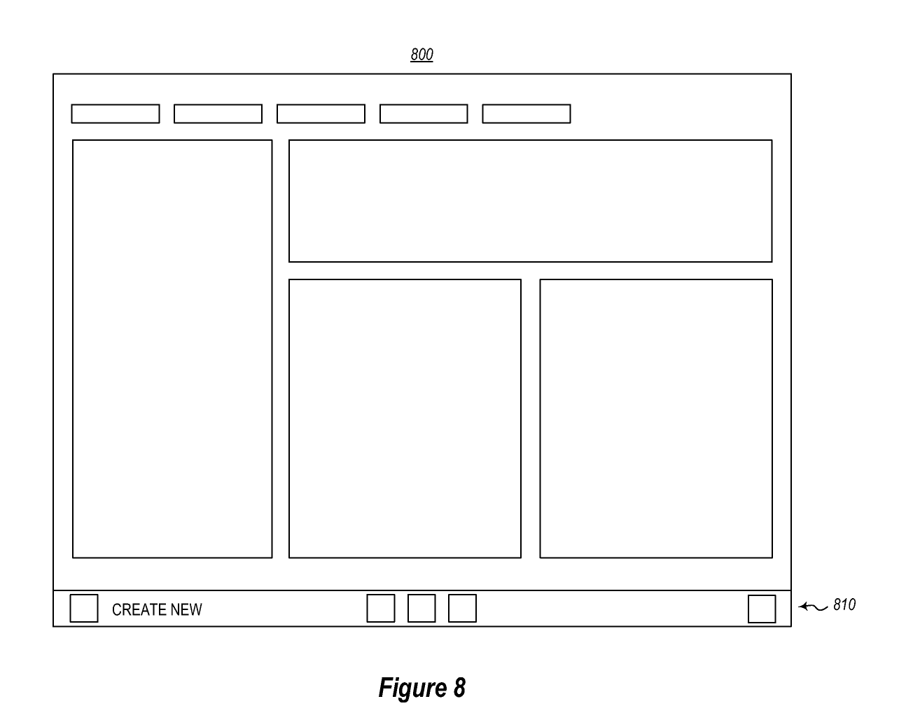

Contextual mode may be used for commands relative to the current content of the primary application work area (e.g. Delete Application, Upload Application Package, Reset User Password commands, and so forth). Contextual mode presents the notification area relative the activity being executed. This context is valuable because it allows the user to understand the origin of their activity. This kind of presentation is often done when the notification area is asking the user to confirm an operation or when a lighter-weight activity is being performed. FIG. 10 illustrates a user interface 1000 in which an activity drawer includes an activity initiation area 1010 in which the user initiates the command using control 1011. In this case, the control actuates an “upload package” command. The activity drawer also includes a notification area 1020 that includes a command space that may be worked on by the user to enter information to complete the uploading of the package.

Notice that the cross hatching of the command control 1011 is the contextual tether for the work needed to complete the activity and that work is presented within the same focus of attention as the command itself. This maintains a fluid user experience. While the principles described are with respect to a drawer, other visualized artifacts may also be used consistent with the principles described herein.

At least one or more of the embodiments of the activity notification described herein have numerous advantages. Again, the user's foci of attention are maintained to help ensure a continuous flow from activity start to activity work. This is done by presenting the “work” experience as a natural extension of the “start” experience.

Furthermore, rather than requiring the user to learn and move between multiple user interface controls/experiences, they are introduced to a single commanding plus activity experience that allows them to perform all of the activities (command actuation, and corresponding task completion) within that framework. This gives them one thing to learn, one place to come back to, and one place to find new product features.

In addition, the activity experience respects the user's content, and is positioned at the periphery of the screen allowing the user to maintain focused and aware of the content they will be affecting with the execution of this command. Traditional approaches of presenting a dialog or wizard on top (and in the center of content) occludes the user's primary content requiring them to remember context, rather than simply being able to look at it. The activity drawer is presented in one location, in the same way, regardless of the activity being performed. It is also entirely on demand in that users do not worry about pinning or auto-collapsing it.

There is no concept of moving the drawer around so that it is positioned in a new location. This provides a management-free or manageless experience. By presenting the control in this way, the control may be made easier to understand and use, and also easier for the user to master. When controls work in consistent and predictable ways, users can start anticipating their operations and move through an experience with improved ease.

3) Global Cascading Create Notifications

Create activities may be initiated by a create control in the activity initiation area. The create activity may create any one of many types of objects. In that case, the notification area may take on a hierarchical cascading structure. For instance, interaction with one or more controls in a first portion of the notification area may affect one or more user interface elements displayed in a second portion of the notification area. Furthermore, interaction of one or more controls in the second portion of the notification area may affect one or more user interface elements displayed in a third portion of the notification area, and so forth. Likewise, if the notification area does including contextual help portions, such context help areas may change responsive to the choices made in the cascading portions of the notification area.

Conventional approaches to content creation are overwhelmingly biased towards a “File→New” menu experience. After selecting an item from the “New Menu”, users are often presented with a dialog for expressing the details of the item they wish to create. Global Cascading Create reduces the cognitive dissonance created by moving from one context “File→New” to another context “Details Dialog” by keeping the entire experience within a user interface control.

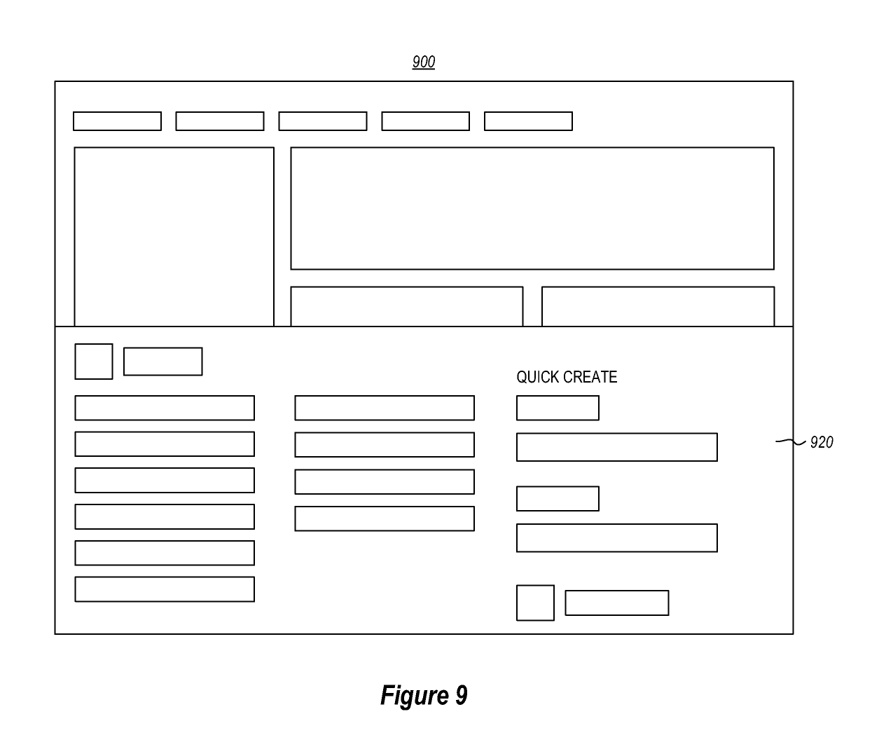

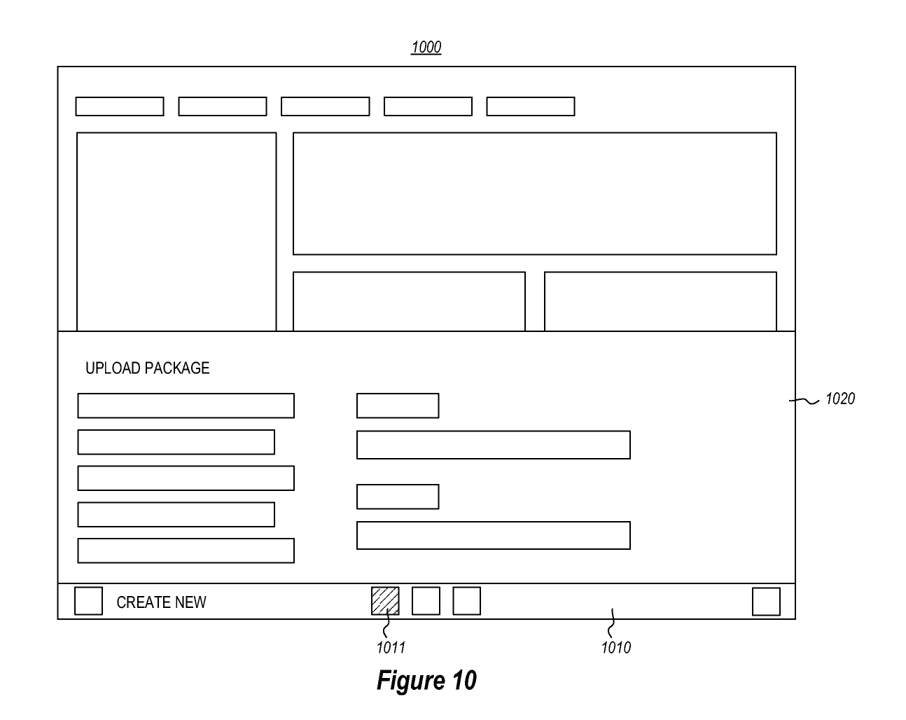

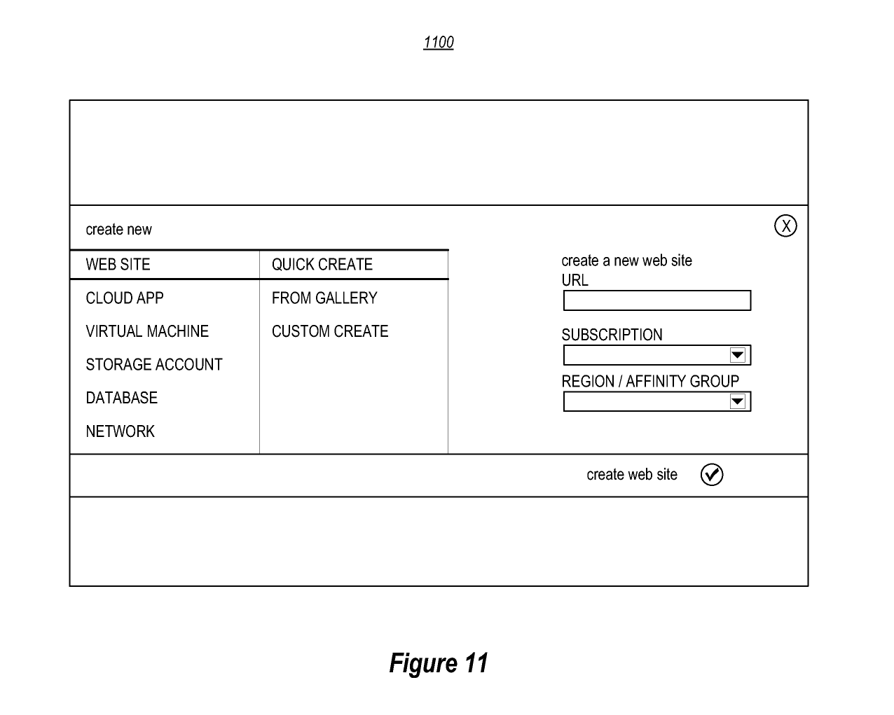

FIG. 11 illustrates an example user interface 1100 that uses the global cascading create concept. FIG. 12 illustrates an example user interface 1200 prior to invoking the global cascade create notification area. The user may invoke the global cascade create notification area by selecting a control such as the “Create New” control 1211 at the bottom left of the activity initiation area 1210 in FIG. 12. An example result of such a control actuation is illustrated in the user interface 1300 of FIG. 13.

As shown in the example of FIG. 13, this causes a notification area 1320 (e.g., a global cascade create drawer“) to slide up above the activity initiation area allowing the Create New task to continue. The user invokes the create command, and is presented with the tools to complete that task within the cognitive and conceptual context of the tasks origin. This delivers a fluid user experience.

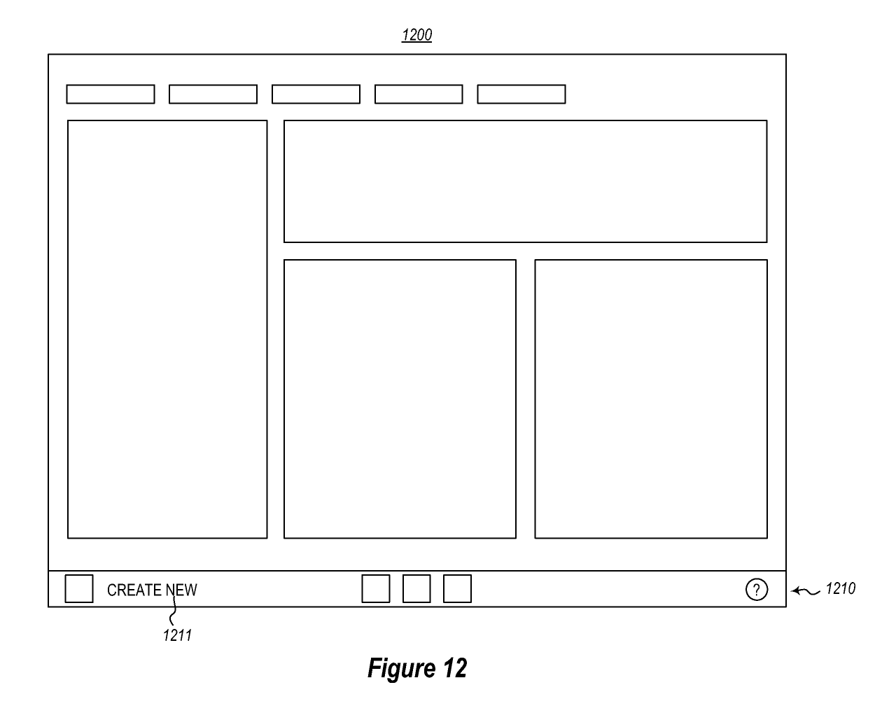

Users can browse through their creation choices using conventional cascading list metaphors. As shown in the user interface 1400 of FIG. 14, a selection in the first list 1421, presents choices in the second list 1422, and so on.

The “Contextual Creation Help” 1321 of FIG. 13 is another aspect of the creation. Rather than pushing this off to the side into some kind of a help button that when invoked presents yet another information context for a user to rationalize, the creation guidance is within element 1321, guiding the user each step of the way. When an item is selected from the second list 1422, the help information 1321 is replaced with the final step in creation: New Item Details 1423. Again, these are presented inline with the larger context of creation. A different dialog is not presented for the user to complete their task as doing so would break the immersion and flow the user has enjoyed up until this point.

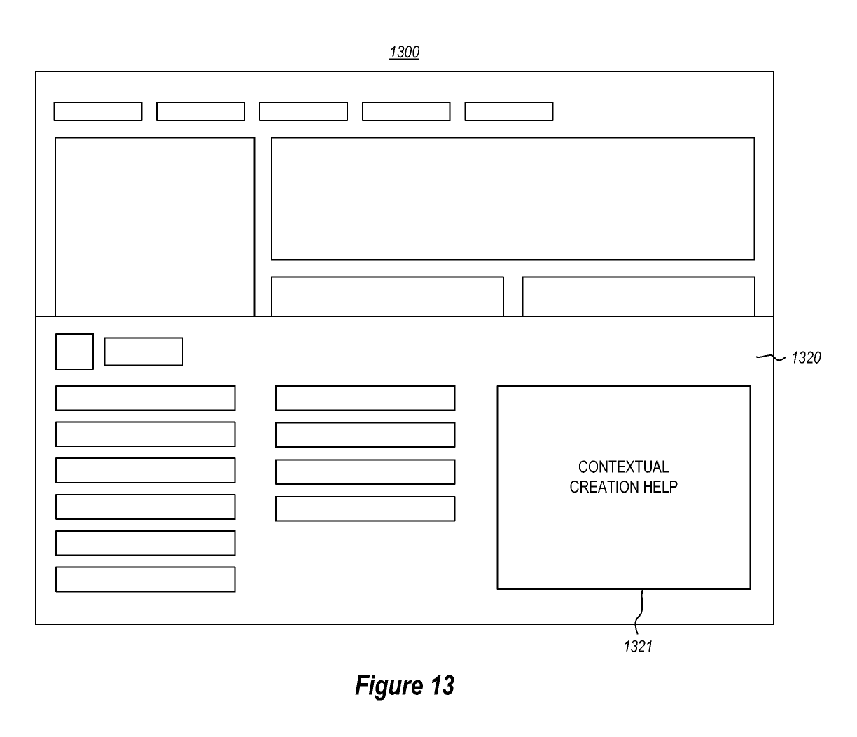

FIG. 15 illustrates the user interface 1500, which is similar to that of FIG. 14, except with example user input provided into the New Item Details section 1403.

When the user is finished fleshing out the New Item Details information, the user may actuate a “Create Item” control 1501 and the item is created. In some embodiments, this might transition into a long running operation task that is presented with the command bar as described further below with respect to the “Signals Notification” concept further below.

Using this global cascade create principle, users are able to move from the goal of creating something new to the realization of that goal within one fluid experience. By embedding the task of providing create details (e.g. name new item) inline with the choices of what to create, the user is able to maintain a full understanding of where and why they are performing their current task. Furthermore, the user is given enough information to incrementally digest the tasks needed to complete the create activity. In addition, rather than lumping creation into a menu with a series of related, but ultimately distracting, adjacent activities, the user is provided with a much more focused and streamlined experience, free of conventional distractions and decisions. Also, in addition to progressively revealing information to the user, step-by-step guidance is provided as to what a decision means and how to move from one step to the next.

4) Signal Notifications

Classically “notifications” (e.g. errors, warnings, long running operations and confirmations) are displayed in a dialog that is center positioned within an application's content area. This makes it more difficult for users to understand what a notification applied to, how to deal with the notification, and so on. Using the drawer signal concept described herein, the notifications are displayed relative to the command or operation from which the notifications originated. For instance, if a user wishes to delete a website, they press a delete control in the activity initiation area. After activating the delete control, they would be presented with a confirmation dialog directly above the delete control button, not in an unrelated area within the user interface.

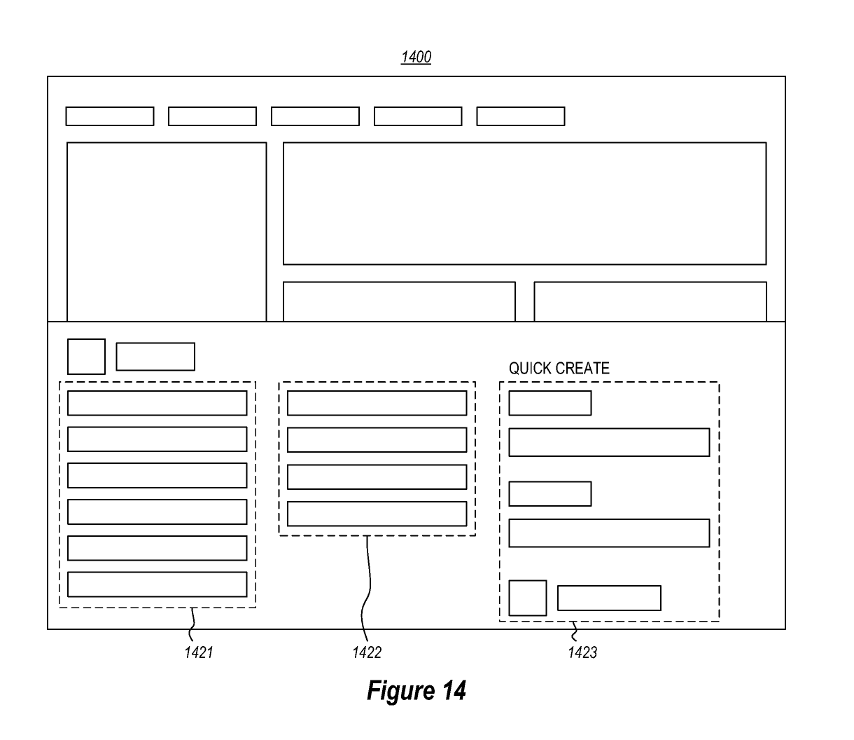

FIG. 16 shows a user interface 1600 that includes a notification area 1620 that shows status for a long running operation (e.g., the creation of a new user account JONNYMAC) causing the long running application status notification area 1620 to appear. The signal notification area 1620 is presented at the bottom of the primary application work area, adjacent to the activity initiation area 1610. Furthermore, the notification area is visually anchored to a specific context (e.g., using a rectangular notch 1630), in this case, the notification area 1620 is anchored to circle 1611. In addition, the signal notification area 1620 provides links to content which enable quick navigation to important information. Also, the signals provide just enough information to be useful, but not too much to be distracting.

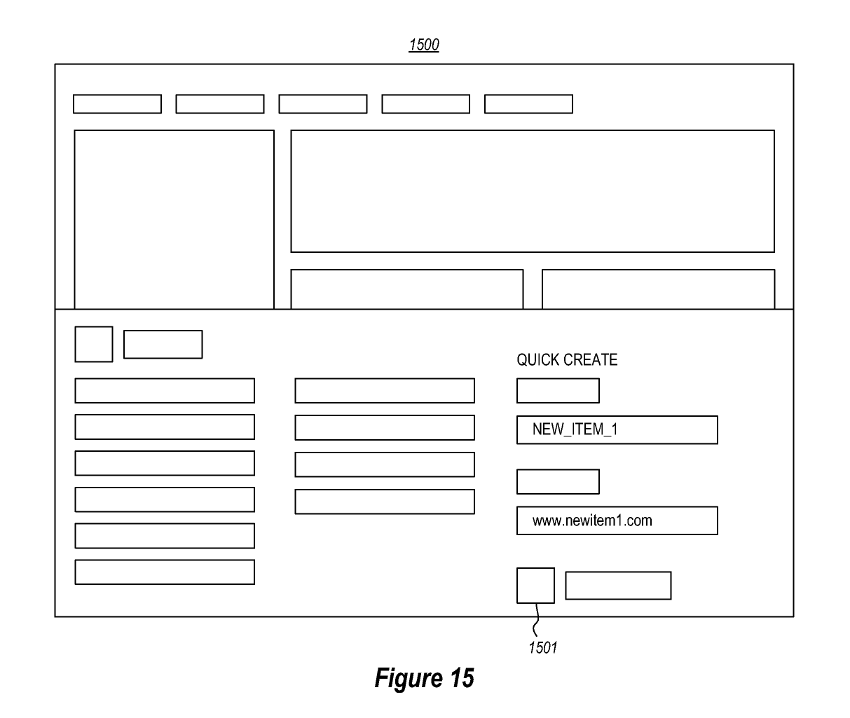

FIG. 17 illustrates the signal notification area 1720 in detail mode, which is expanded when the user selects the expansion control 1631 of FIG. 16. The user can return to the minimal mode by selecting contraction control 1731 of FIG. 17.

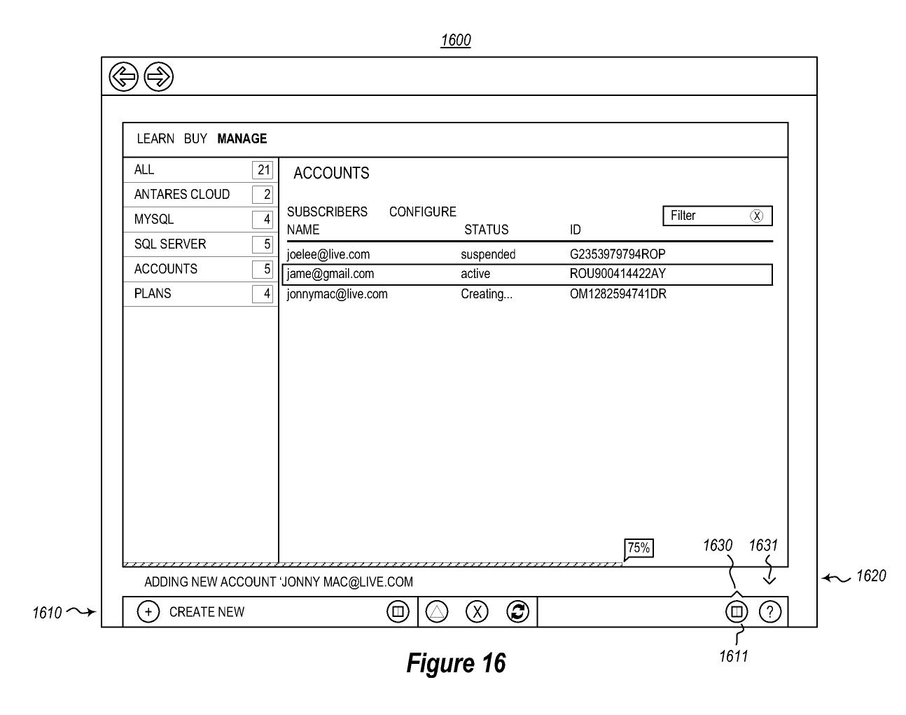

The information presented in the signals notification area can often be very rich. Users can drill into content to see even more details, without leaving the confines of the notification area and without cluttering their user interface with popups. FIG. 18 illustrates a user interface 1800 that shows a drilled-in view of content within the notification area 1820. For instance, the left area that includes wavy lines could include very detailed information regarding the error.

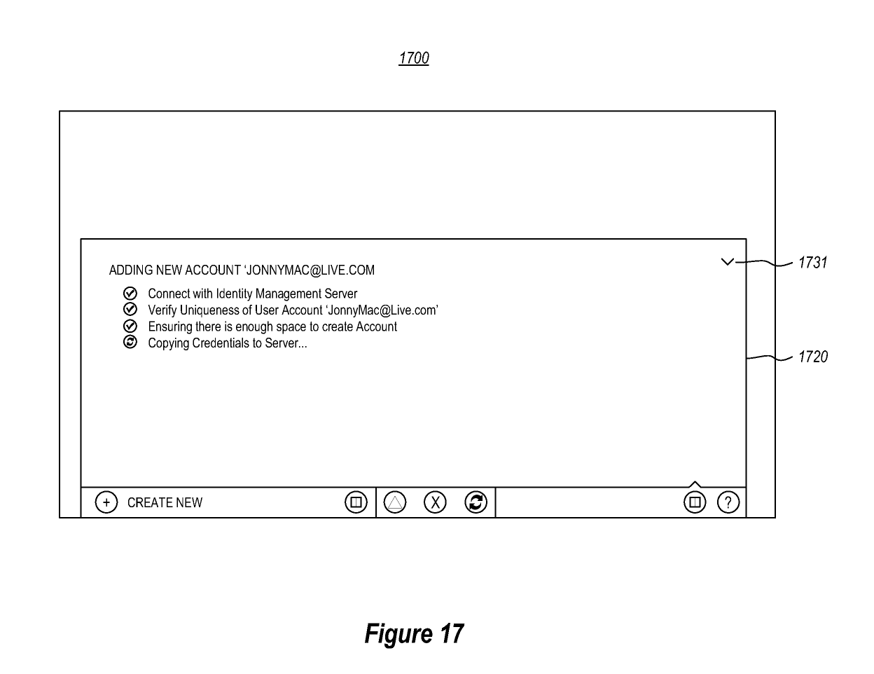

FIG. 19 illustrates that the notification area 1920 may present multiple long running operations in a single location.

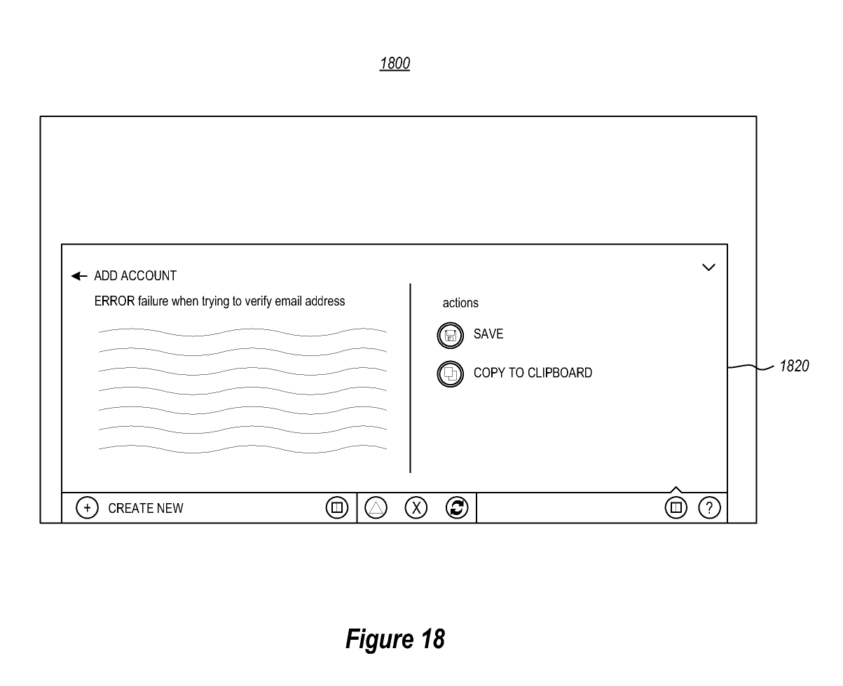

Above, signals are described as being presented for long running operations. They are also applied to error, warning and confirmation scenarios. A key scenario for signals is confirmation. Primarily this is done as a popup dialog. As shown in FIG. 20, the signal notification area 2020 presents the confirmation experience directly adjacent to the command that requires confirmation.

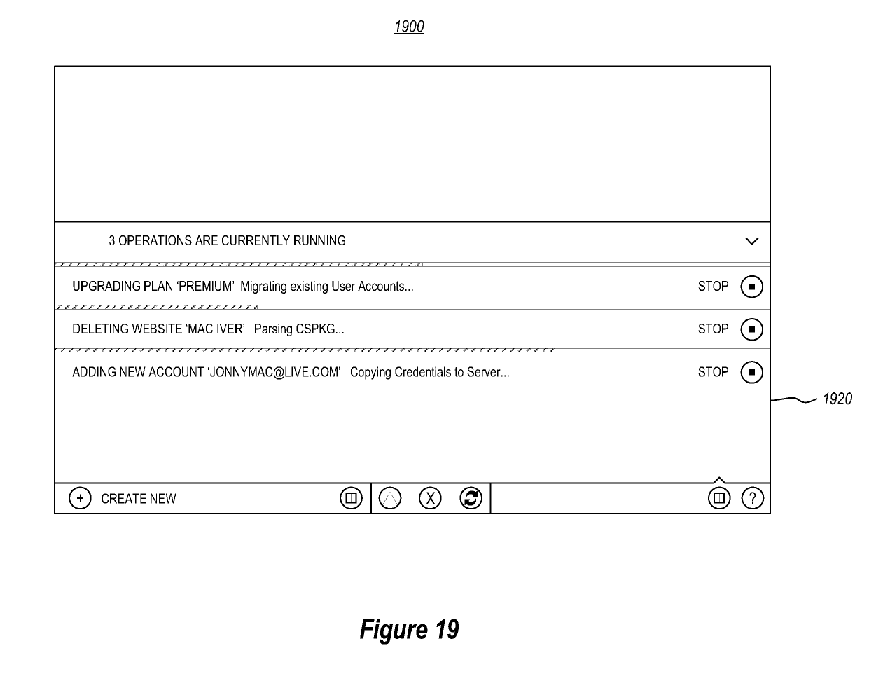

Again, the confirmation can be expanded to show more information, should the user need it. If they do not need that further information (e.g., because they are familiar with their environment/domain), then they do not need to be distracted with it, and they can avoid the detail view. FIG. 21 illustrates the expanded signal notification area 2120 of the confirmation. Note that the confirmation signal has a control which asks the user to accept confirmation 2021 or reject confirmation 2022.

The detailed view provides richer context information, about the affected items associated with the command, carrying out the concept of a content aware experience.

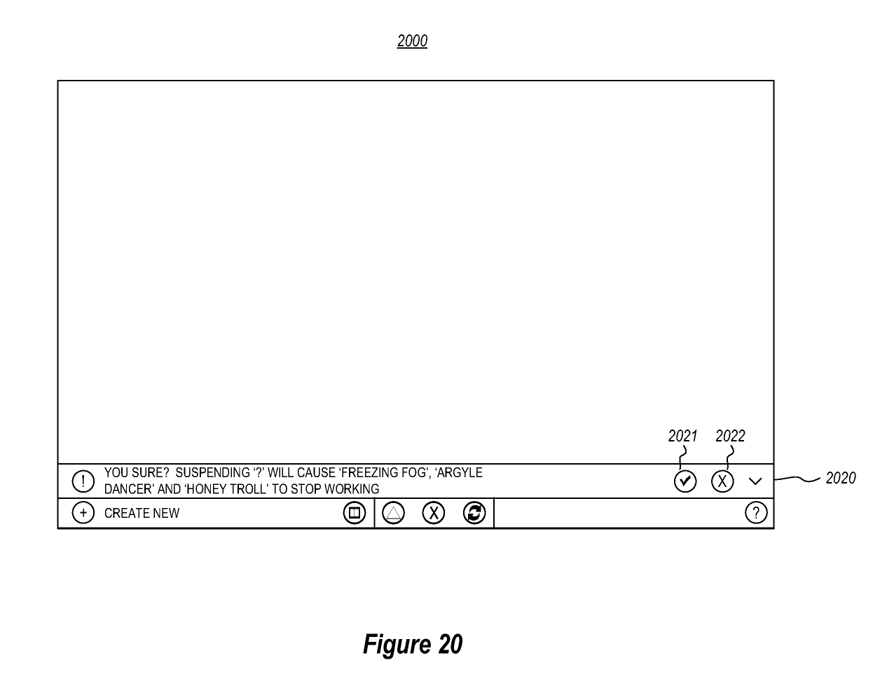

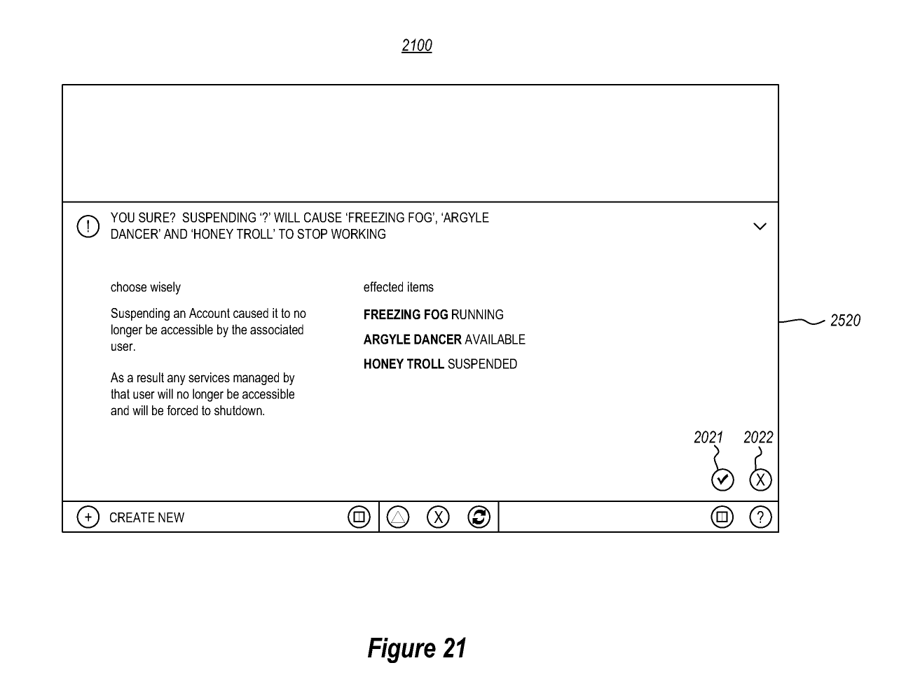

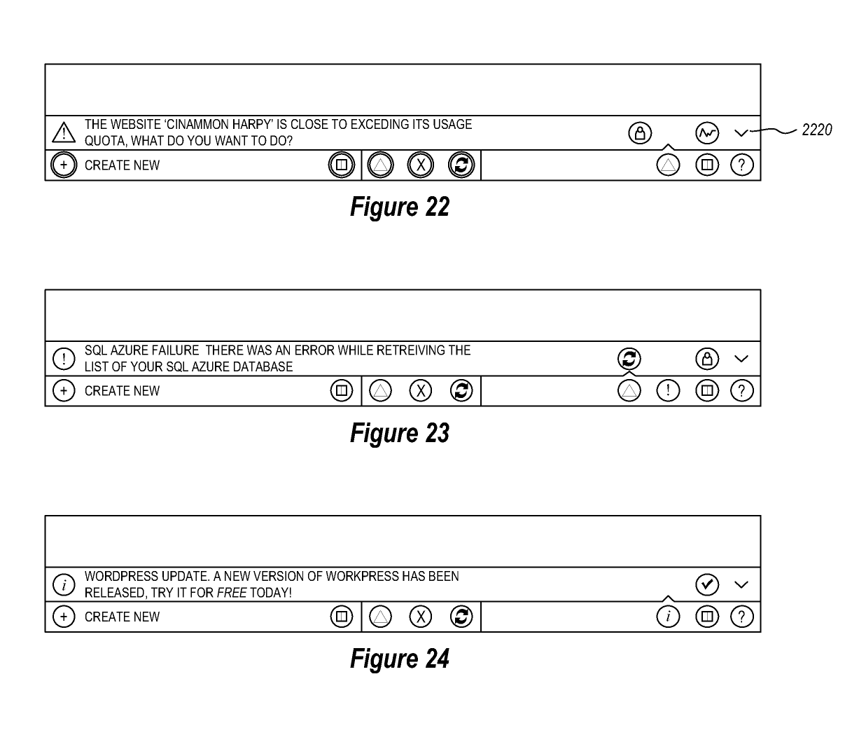

System warnings, which pertain to the user's account (e.g. they are near their storage limit) may also presented via the signals notification area. Unlike conventional approaches, which place this kind of information in a different content page or area, system information is easy to access and understand due to a familiar presentation. FIG. 22 illustrates a signal notification area 2220 that presents such a system warning. Systems errors (see FIG. 23) and information notifications (see FIG. 24) may be treated the same way such as in the following.

The signal notification area avoids breaking the user's foci of attention by presenting notifications in a consistent and central location, with visual anchors to the context of the notification. Rather than requiring the user to learn and move between multiple user interface controls/experience, a single consistent notification experience is presented and is applied with appropriate optimizations for errors, warnings, long running operations and confirmations. Notifications are presented at the periphery of the user's content area. This avoids occluding user content and causing them to remember what they were working on or having to mentally recall the information they may need to take action against a notification.

Notifications are presented in a management free manner. Rather than popup in a dialog that is distracting and requires the user to dismiss it or reposition it, notifications appear, can be actioned against, and then auto-close as soon as the user moves to another task (e.g. clicks on content).

Notifications are presented in a minimal form with just enough information to understand what needs to be done, or what is happening in the system. Users can then expand a notification to see more information. They can further drill into more information to dig even deeper. All of this is done progressively to ensure the user is not overwhelmed or distracted by too much information. Classic dialogs are unable to deliver this same type of experience due to their fundamental design approach.

The notification is both content and navigation aware, and because it is a core piece of the shell, rather than a popover dialog, links to content can be presented in a notification. For instance, when a user is watching the creation progress of new website, then can jump to the list of all websites via a simple link.

Accordingly, the principles described herein provide an effective and mechanism for providing various notifications to a user related to an activity that has been, or may be, initiated by the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to display a user interface on a display of the computing system, the user interface comprising:
an activity initiation control displayed in at an activity initiation area in the user interface, wherein the activity initiation control may be interacted with in order to initiate an activity; and
a notification area in which one or more notifications related to the activity may be displayed, wherein the notification area is spatially related to the activity initiation control in a fixed manner for a plurality of activities.

2. The computer program product in accordance with claim 1, wherein the activity initiation area is hidden when the notification area is displayed.

3. The computer program product in accordance with claim 1, wherein the activity initiation area remains when the notification area is displayed.

4. The computer program product in accordance with claim 1, wherein the activity initiation area appears extended along a boundary of the user interface, wherein the notification area also appears along the boundary of the user interface and extends further in a direction away from the boundary as compared to the activity initiation area.

5. The computer program product in accordance with claim 4, wherein the boundary is a horizontal boundary.

6. The computer program product in accordance with claim 5, wherein the horizontal boundary is a lower boundary.

7. The computer program product in accordance with claim 4, wherein the notification area has the same position along the direction of the boundary as the activity initiation area.

8. The computer program product in accordance with claim 1, wherein the activity initiation control is a create control that may be used to create any one of a plurality of objects, wherein the notification area comprises a hierarchical notification area in which interaction with one or more controls in a first portion of the notification area affect one or more user interface elements displayed in a second portion of the notification area.

9. The computer program product in accordance with claim 8, wherein interaction of one or more controls in the second portion of the notification area affect one or more user interface elements displayed in a third portion of the notification area.

10. The computer program product in accordance with claim 8, wherein the second portion of the notification area includes contextual creation help elements.

11. The computer program product in accordance with claim 1, wherein the notification area includes an expansion control that may be selected to display more details.

12. The computer program product in accordance with claim 1, wherein the notification area includes a link that may be selected to navigate to further content related to the one or more notifications.

13. The computer program product in accordance with claim 1, wherein the notification area appears upon interaction with the activity initiation control to initiate an activity, wherein the one or more notifications related to the initiated activity.

14. The computer program product in accordance with claim 13, wherein the user interface further comprises a contextual tether connecting the notification area with the activity initiation control.

15. The computer program product in accordance with claim 13, wherein at least one of the one or more notifications comprises a progress notification associated with the initiated activity.

16. The computer program product in accordance with claim 13, wherein the one or more notifications include a warning or error related to the initiated activity.

17. The computer program product in accordance with claim 13, wherein the one or more notifications include a confirmation related to the initiated activity.

18. The computer program product in accordance with claim 1, wherein the one or more notifications include a help message related to an activity that may be initiated through interaction with the activity initiation control.

19. A computer-implemented method for implementing a user interface on a display of a computing system, the method comprising:
an act of displaying an activity initiation control in at an activity initiation area in the user interface, wherein the activity initiation control may be interacted with in order to initiate an activity; and
displaying a notification area in which one or more notifications related to the activity may be displayed, wherein the notification area is spatially related to the activity initiation control in a fixed manner for a plurality of activities.

20. A computer-implemented method for implementing a user interface on a display of a computing system, the method comprising:
an act of displaying an activity initiation area in a user interface displayed on the display, the activity initiation area including an activity initiation control;
an act of detecting interaction with the activity initiation control;
in response to the detected interaction, act of initiating an activity and an act of displaying a notification area in which one or more notifications related to the activity may be displayed, wherein the notification area is spatially related to the activity initiation control in a fixed manner for a plurality of activities.
